(19) United States
(12) Patent Application Publication
(10) Pub. No.: US 2002/0116255 A1
(43) Pub. Date: Aug. 22, 2002

(54) Marketing methods and business personnel marketing methods

(76) Inventors: Diana Goodwin, Meridian, ID (US); Margo N. Whale, Kuna, ID (US)

Correspondence Address: HEWLETT-PACKARD COMPANY, Intellectual Property Administration, P.O. Box 272400, Fort Collins, CO, 80527-2400, US

(21) Appl. No.: 09/790,367

(22) Filed: Feb. 21, 2001

(51) Int. Cl. G06F 17/60

(52) U.S. Cl. 705/11

(57) ABSTRACT

Marketing methods and business personnel marketing methods are described. According to a first aspect, a marketing method includes the following steps: obtaining product data from a plurality of business personnel associated with one or more business entity, the product data regarding a product used by the one or more business entity; obtaining personal data from the business personnel regarding the business personnel themselves; first associating the personal data of the business personnel with a plurality of business attitude segments regarding the product and responsive to the respective product data of the business personnel; and second associating the business attitude segments with a plurality of consumer attitude segments using the respective personal data.

### FIELD OF THE INVENTION

This invention pertains to marketing methods and business personnel marketing methods.

### BACKGROUND OF THE INVENTION

Numerous companies are increasingly attempting to break into and/or enhance a percentage of the business market for their product. Business to business (B2B) selling is growing in prevalence as a strategy for companies to sell products due to businesses' typical high purchasing volume and potential contracts for long term selling. Business to business target marketing is a relatively new area of marketing. For example, target marketing has not yet reached the advancements experienced in consumer marketing. For many business to business companies, the techniques for effective target marketing are very limited.

To target or design their products and messaging in accordance with conventional methods, companies typically rely upon meeting the needs of their customer companies as defined by their demographics, such as: region, industry, or site size. However, as competition in the business to business market increases, companies are working to more specifically understand their customer's purchasing behaviors, which are often not linked to site size, region or industry. Consequently, as companies move toward understanding their customers attitudes, needs and behaviors in order to create products, programs and messaging, companies are looking for market research that can provide more tangible ways of reaching customers scattered throughout site sizes, regions and industries.

For example, a given company may desire to increase the sales of their products by designing a well-targeted and appealing message toward a group of their business customers defined by attitudes, needs and behaviors around a product. However, these customer groups typically have no single location that is identifiable by traditional business to business marketing demographics (site size, region, industry). Even though the company may do market research to reveal the attitudes and behaviors of a particular group of customers, these customers are scattered throughout all regions, site sizes and industries which makes targeted marketing difficult. In sum, in typical business to business marketing scenarios, business attitude segments do not correlate with any company demographic—site size, region, industry. Consequently, acting on business attitude segmentation research becomes extremely difficult and often makes business attitude segmentation unusable for active business to business selling.

There exists a need to provide improved methodologies for marketing which overcome problems associated with conventional methodologies.

### SUMMARY OF THE INVENTION

The invention provides marketing methods and business personnel marketing methods.

According to a first aspect of the invention, a marketing method comprises the following steps: obtaining product data from a plurality of business personnel associated with one or more business entity, the product data regarding a product used by the one or more business entity; obtaining personal data from the business personnel regarding the business personnel themselves; first associating the personal data of the business personnel with a plurality of business attitude segments regarding the product and responsive to the respective product data of the business personnel; and second associating the business attitude segments with a plurality of consumer attitude segments using the respective personal data.

A second aspect of the invention provides a marketing method comprising the following steps: identifying a plurality of business personnel associated with a product used by one or more business entity; providing a first file responsive to the identifying, the first file comprising a plurality of business attitude segments of the business personnel regarding the product and personal data of the business personnel; and providing a second file using the business attitude segments and the personal data of the first file, the second file associating a plurality of consumer attitude segments with the business attitude segments.

Another aspect of the invention provides a business personnel marketing method comprising the following steps: first identifying a plurality of business personnel associated with a product used by one or more business entity; linking the business personnel to respective consumer identities; and associating the business personnel with a plurality of consumer attitude segments after the linking. The invention includes other aspects as disclosed herein.

Other features and advantages of the invention will become apparent to those of ordinary skill in the art upon review of the following detailed description, claims, and drawings.

### DESCRIPTION OF THE DRAWINGS

FIG. 1 is a functional block diagram depicting a plurality of entities configured to implement exemplary marketing aspects of the present invention.

FIG. 2 is a flow chart depicting an exemplary methodology for implementing marketing aspects of the present invention.

### DETAILED DESCRIPTION OF PREFERRED EMBODIMENTS

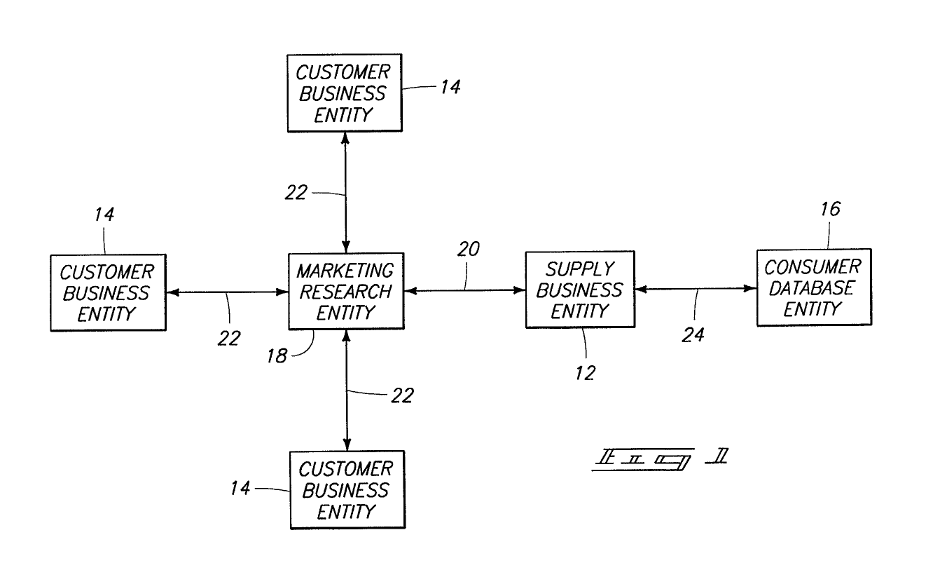

Referring to FIG. 1, a supply business entity 12, plural customer business entities 14, a consumer database entity 16 and marketing research entity 18 are depicted in an exemplary configuration. In the described arrangement, supply business entity 12 is coupled with a consumer database entity 16 and marketing research entity 18. More specifically, supply business entity 12 is coupled with marketing research entity 18 via an appropriate communication medium 20. Further, supply business entity 12 is coupled with consumer database entity 16 via an appropriate communication medium 24.

Communication media 20, 24 are configured to communicate or exchange information or data, such as electronic files, intermediate respective entities 12, 16, 18. Exemplary arrangements of communication media 20, 24 comprise network connections, such as the Internet, diskettes, or other media for communicating information. In such arrangements, entities 12, 16, 18 include appropriate devices, such as personal computers, workstations, etc. to implement communications via media 20, 24.

In addition, a communication medium 22 is utilized by marketing research entity 18 to access respective customer business entities 14. In exemplary arrangements, communication medium 22 is implemented via telephone communications, electronic communications (e.g., via e-mail), traditional mail such as completion of marketing postcards, etc.

Supply business entity 12 is arranged to provide one or more product used or consumed by customer business entities 14. Supply business entity 12 and customer business entities 14 typically are companies or corporations. Accordingly, in some aspects of the invention, business to business (B2B) marketing methods are provided.

An exemplary supply business entity 12 is a manufacturer of product such as Hewlett-Packard Company which manufactures products such as printers, personal computers, and other electronic equipment as well as consumables (e.g., toner) for use in such devices. Supply business entity 12 sells either directly or through resellers (not shown) to customer business entities 14 in some implementations.

Customer business entities 14 individually include, in some arrangements, one or more business personnel employed or associated with the respective entity and also associated with a product used by the respective entities 14. For example, exemplary business personnel include purchasing agents responsible to purchase a product, such as toner, from supply business entity 12. Product of supply business entity 12 is used or consumed by the respective customer business entities 14. Aspects of the present invention provide improved methods for marketing products sold by supply business entity 12 to customer business entities 14 and to such business personnel of entities 14.

Consumer database entity 16 operates a database, such as a consumer database, which includes data regarding consumers in the described embodiment. An exemplary consumer database includes national collections of data from households regarding items of common purchase and lifestyle of the household (e.g., vacations overseas, exercise prevalence, disposable income, television/movie viewership, gardening practices, use of various products from tobacco to diapers). Such consumer databases are used for marketing efforts of household goods such as toothpaste, packaged foods, laundry detergent, refrigerators, washing machines, cars, etc. These databases reveal trends wherein people who live in a given neighborhood typically follow similar consumer buying habits of other people within the same or similar neighborhood.

Consumer databases are utilized to provide consumer attitude segments that have the highest potential for purchasing a particular product. Individuals within one consumer attitude segment typically have similar buying habits of other consumers of the same consumer attitude segment. Consumer database entity 16 identifies consumer attitude segments for which marketing can be tailored for improved effectiveness regarding the product of entity 12. Exemplary consumer attitude segments identify traits of consumers including geographic locations (e.g., residences) of consumers, such as geographic regions or zip codes, lifestyles of consumers, media habits of consumers including, for example, magazines read, watching of television shows, listening to radio programing, etc. An exemplary consumer database is operated by Spectra Marketing Systems, Inc. which provides consumer attitude segments in the form of “lifestyles.”

Consumer databases are not applicable in business environments because the locations of business personnel within the consumer databases are not identifiable using conventional business to business marketing demographics (site size, region, industry, etc.). As described herein, aspects of the present invention enable supply business entity 12 to utilize consumer database entity 16 for marketing to business personnel within customer business entities 14.

According to exemplary aspects of the invention, supply business entity 12 utilizes marketing research entity 18 for the purposes of obtaining personal data regarding business personnel of customer business entities 14 to enable use of consumer database entity 16 to market to such business personnel. An exemplary marketing research entity 18 is RS Consulting, Inc. Marketing research entity 18 is operable to retrieve information from business personnel of customer business entities 14. Marketing research entity 18, in the described embodiment, is utilized to obtain information from such business personnel to identify business attitude segments of the business personnel regarding the product and to link or associate the business personnel and/or the business attitude segment to consumer identities for usage within consumer database entity 16.

Marketing research entity 18 obtains personal data regarding the business personnel themselves as well as product data or information regarding attitudes of the business personnel towards one or more product of supply business entity 12. As described further below, the product data is utilized to associate or identify business attitude segments of the business personal with respect to the product and the personal data is utilized to identify consumer attitude segments for the business personnel. Business and consumer attitude segmentation is described in James H. Myers, Segmentation and Positioning For Strategic Marketing Decisions, 1996, incorporated herein by reference.

In accordance with aspects of the present invention, supply business entity 12 furnishes marketing research entity 18 with an identification of business personnel associated with customer business entities 14 for which product data and personal data is desired. For example, business personnel identified by supply business entity 12 are associated with a product used within the customer business entities 14 and supplied by entity 12. Exemplary business personnel include purchasing agents, users of product, or people otherwise familiar with products sold by supply business entity 12.

In one embodiment of the invention, supply business entity 12 communicates a file to marketing research entity 18 which identifies desired business personnel associated with one or more customer business entity 14. An exemplary file is an Excel(tm) compatible file which is communicated via appropriate medium 20 from supply business entity 12 to marketing research entity 18. Alternatively, entity 12 identifies the business personnel by accessing a business database, such as available from Dun and Bradstreet, Inc. Other methodologies are possible for identifying the desired business personnel to be targeted.

Marketing research entity 18 thereafter accesses appropriate business personnel within respective customer business entities 14 to obtain the desired product data and personal data to enable execution of an appropriate attitudes and behaviors segmentation study. The present invention encompasses any technique or methodology for obtaining product data from the business personnel regarding one or more product sold by supply business entity 12 and personal data regarding the business personnel themselves.

For example, marketing research entity 18 submits questions regarding the product and the business personnel themselves to the business personnel and compiles responses to the questions in one arrangement. The exchange of information from entity 18 and business personnel of entities 14 is implemented in any satisfactory method using media 22. Data is exchanged via telephone, email, postcards, or other methodology via media 22.

Exemplary questions submitted to business personnel of entities 14 include questions regarding the products, such as satisfaction or dissatisfaction with the product, characteristics of the product, improvements to the product, desired features of the product, etc. Additional questions include purchasing habits of the personnel themselves, including as quality and/or price concerns, are possible. Such questions inspire answers to provide desired product data utilized to implement marketing methodologies of the present invention including providing respondents in appropriate business attitude segments.

Linking or driving questions are also presented to enable linking or associating of the business personnel and/or their respective business attitude segments with locations within consumer databases to provide association thereof with consumer attitude segmentation information. Such questions associate business personnel and/or their respective business attitude segments with consumer identities. Exemplary linking questions comprise questions with respect to the business personnel themselves and include, for example, geographic location questions (e.g., zip code of residence), number of children, household income, etc. Such questions are provided to inspire answers which reveal the desired personal data of the business personnel which is used to search the consumer databases for obtaining the respective consumer attitude segmentation information for the business personnel and/or business attitude segments thereof. Other techniques or methodologies may be utilized to obtain product data and personal data from the business personnel.

Responsive to the product data, the business personnel are individually associated with one of a plurality of business attitude segments regarding the product. Exemplary business attitude segments, also referred to as business segments, include “brand loyal”, “price sensitive”, etc. Such business attitude segments correspond to purchasing prospectus of purchasers of the product and the buying habits of the desired business personnel. In the described arrangement, marketing research entity 18 identifies or associates business personnel with appropriate respective business attitude segments. The personal data from the business personnel is also associated with or identified with the appropriate business attitude segments. Details according to one exemplary aspect of the present invention regarding association of business personnel and respective personal data thereof with business attitude segments is described in Segmentation and Positioning For Strategic Marketing Decisions, incorporated by reference above.

Personal data from the business personnel is used to link the business personnel and/or their business attitude segments to locations within a consumer database such as within consumer database entity 16 to implement marketing techniques according to aspects of the invention and as described in further detail below.

According to the described exemplary embodiment, marketing research entity 18 communicates the obtained information including identification of the responding business personnel, the respective business attitude segments of the business personnel, and personal data of the respective business personnel themselves. In the described embodiment, the information is communicated using an electronic file, such as an Excel(tm) file. The file is outputted from marketing research entity 18 and communicated via medium 20 to supply business entity 12.

It is desired to link or associate business personnel of customer business entities 14 and/or their respective business attitude segments with consumer identities for usage of the consumer database of consumer database entity 16. Consumer database entity 16 is utilized to identify one or more consumer attitude segment with respect to the product supplied by supply business entity 12 after the linking of business personnel and/or business attitude segments thereof to respective consumer identities. In the depicted arrangement, supply business entity 12 provides the electronic file received from marketing research entity 18 or other electronic file to consumer database entity 16. The electronic file provided to consumer database entity 16 includes personal data, business attitude segment, and unique identifiers for (associated with) respective business personnel. The unique identifiers identify the personal data and business attitude segment with the respective responding business personnel.

According to aspects of the invention, business personnel and/or business attitude segments thereof are linked or associated with a plurality of consumer attitude segments using the personal data by consumer database entity 16. Consumer database entity 16 searches the consumer database using the personal data associated with the business personnel and/or the business attitude segments to associate the business personnel and/or business attitude segments with appropriate consumer attitude segments using, for example, appropriate marketing research principles such as discriminant functions, clustering techniques, etc.

Exemplary consumer attitude segments identify or characterize consumers in one or more way, such as geographical location, lifestyles, media habits, etc. Exemplary consumer attitude segments of Spectra Marketing Systems, Inc. are identified within The Spectra Grid(tm) and referred to as lifestyles and/or lifestages, such as upscale suburbs, traditional families, mid/upscale suburbs, metro elite, working class towns, rural towns and farms, mid-urban melting pot, downscale rural, and downscale urban. The Spectra Grid(tm) is described at http://www.spectramarketing.com/grid.html, incorporated herein by reference.

Consumer database entity 16 identifies one or more consumer (or business) attitude segment for one or more business (or consumer) attitude segment using the data received from an appropriate entity 12, 18 (e.g., for a given business attitude segment, such as “brand loyal”, at least one consumer attitude segment including geographical information, lifestyle, and/or media habit information is provided for targeted marketing). Identified consumer attitude segment(s) identify the geographical location, lifestyle, media habits, and/or other information wherein the respective business attitude segment(s) business personnel live or may be reached through media advertisement (e.g., television and/or radio programming, magazines, etc.). Accordingly, once one or more appropriate consumer attitude segment is identified for individual business attitude segments(s), marketing is tailored for the product of supply business entity 12. One or more business attitude segment is identified for one or more consumer attitude segment in other aspects of the invention and marketing is tailored following such identification. Further details performed by an exemplary consumer database entity 16 in accordance with some aspects of the invention are described in Spectra Media Targeting Overview, by Spectra Marketing Systems, Inc., pp 1-39 1999, incorporated by reference herein.

According to one aspect, the identifying of at least one consumer (or business) attitude segment for a given business (or consumer) attitude segment includes identifying the consumer (or business) attitude segment having the greatest number of the respective business (or consumer) attitude segments associated therewith (e.g., greatest concentration or penetration) as determined by consumer database entity 16 using the associated personal data.

In other arrangements, a plurality of consumer (or business) attitude segments are identified for individual business (or consumer) attitude segments providing a distribution of different consumer (or business) attitude segments with respect to a given business (or consumer) attitude segment of the product (e.g., consumer database entity 16 identifies plural consumer attitude segments corresponding to a given business attitude segment). In one arrangement, one or more index is provided illustrating penetration of consumer (or business) attitude segments for one or more business (or consumer) attitude segment.

Following association of business attitude segments with consumer attitude segments with respect to the product, consumer database entity 16 communicates such data in an appropriate file to supply business entity 12 using communication medium 24. Supply business entity 12 or other appropriate entity performs desired tailored marketing to desired attitude segments using the business and consumer attitude segmentation information (e.g., advertising messages via appropriate media (television, radio, magazines, etc.) in desired geographical locations).

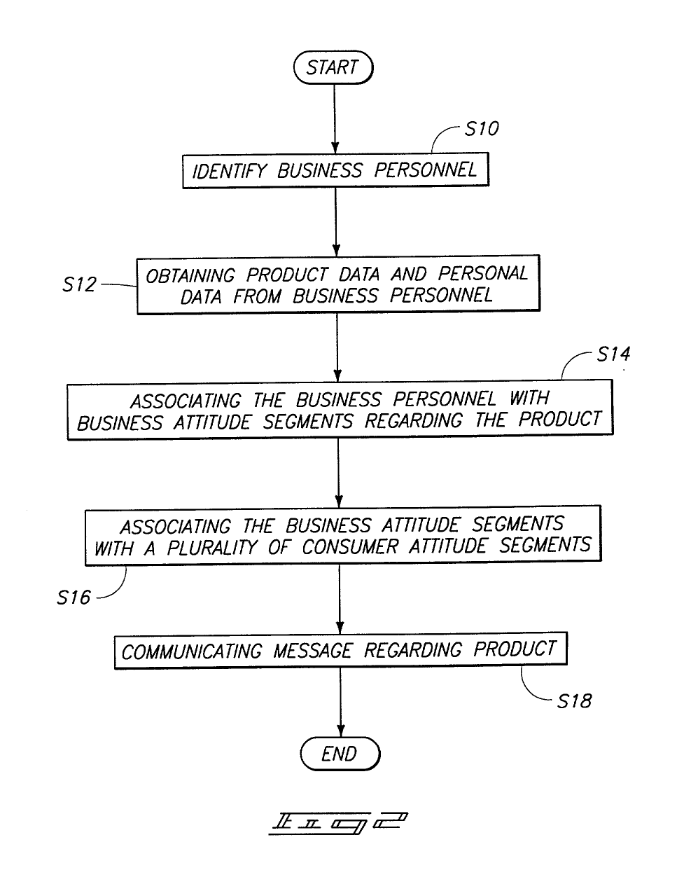

Referring to FIG. 2, an exemplary methodology for implementing exemplary marketing aspects of the present invention is shown. The illustrated methodology is implemented using the entities of FIG. 1. Other configurations or arrangements for implementing the depicted methodology are possible.

At a step S10, business personnel are identified within respective customer business entities 14 to be contacted to obtain personal and product data. In exemplary arrangements, one of entities 12, 18 provides the identification information.

At a step S12, marketing research entity 18 obtains product data and personal data from the business personnel within the respective customer business entities 14.

At a step S14, marketing research entity 18 associates the business personnel (and respective personal data thereof) with business attitude segments regarding the product using the respective product data received from the business personnel. The business attitude segments, personal data and unique identifiers of respective business personnel are communicated to consumer database entity 16 perhaps via entity 12.

At a step S16, consumer database entity 16 associates the business attitude segments with the consumer attitude segments. Consumer database entity 16 searches an internal consumer database using the personal data to associate business attitude segments (and perhaps respective business personnel thereof) with appropriate consumer attitude segments. Further, such association may include identifying one or more business attitude segment for individual ones of the consumer attitude segments, or vice versa, as described above. For example, in one arrangement, an attitude segment (business or consumer) having the highest concentration is identified for each other attitude segment (consumer or business). Alternatively, a plurality of attitude segments (business or consumer) are identified for individual ones of the other attitude segments (consumer or business) in one or more respective index. The consumer attitude segmentation and business attitude segmentation information is communicated to supply business entity 12.

At a step S18, supply business entity 12 formulates and communicates a message regarding their product using the obtained consumer attitude segment information and/or business attitude segment information.

For example, a message directed towards “brand loyal” business attitude segment business personnel is formulated and directed to the consumer attitude segment having the greatest concentration or penetration of “brand loyal” business personnel (e.g., the message is broadcast in the appropriate geographical location including the highest concentration of “brand loyal” consumers and/or to media used by the greatest concentration of “brand loyal” business personnel) in one arrangement.

In addition, the same or different messages regarding a product may be formulated and communicated for different business (or consumer) attitude segments of the product using the respective business or consumer attitude segmentation information (e.g., one message for the product may correspond to a first desired attitude segment while another message may correspond to another attitude segment or the same message may be alternatively used for all attitude segments). The messages are formulated and communicated to the desired business personnel of the different business or consumer attitude segments using respective attitude segmentation information.

As mentioned herein, the disclosed embodiments of the invention are exemplary for the purpose of illustrating exemplary aspects of the present invention. Other arrangements or embodiments of the invention are possible. For example, supply business entity 12 may comprise one or more of consumer database entity 14 and/or marketing research entity 18 according to other such embodiments. Alternatively, the methodologies described herein are implemented within other structural configurations.

The protection sought is not to be limited to the disclosed embodiments, which are given by way of example only, but instead is to be limited only by the scope of the appended claims.

What is claimed is:

1. A marketing method comprising the following steps:
obtaining product data from a plurality of business personnel associated with one or more business entity, the product data regarding a product used by the one or more business entity;
obtaining personal data from the business personnel regarding the business personnel themselves;
first associating the personal data of the business personnel with a plurality of business attitude segments regarding the product and responsive to the respective product data of the business personnel; and
second associating the business attitude segments with a plurality of consumer attitude segments using the respective personal data.

2. The method in accordance with claim 1 further comprising identifying one of the consumer attitude segments for an individual one of the business attitude segments responsive to the second associating.

3. The method in accordance with claim 2 wherein the identifying comprises identifying the one of the consumer attitude segments having the greatest concentration of the individual one of the business attitude segments associated therewith.

4. The method in accordance with claim 2 wherein the identifying identifies geographical locations of business personnel within the at least one consumer attitude segment.

5. The method in accordance with claim 2 wherein the identifying identifies media habits of business personnel within the at least one consumer attitude segment.

6. The method in accordance with claim 1 further comprising providing an index identifying a plurality of business attitude segments for an individual one of the consumer attitude segments responsive to the second associating.

7. The method in accordance with claim 1 further comprising providing an index identifying a plurality of consumer attitude segments for an individual one of the business attitude segments responsive to the second associating.

8. The method in accordance with claim 1 further comprising communicating a message regarding the product responsive to the second associating.

9. The method in accordance with claim 1 wherein the obtaining product data and the obtaining personal data comprise submitting questions regarding respective ones of the product and the business personnel themselves to the business personnel and compiling replies to the questions.

10. The method in accordance with claim 1 wherein the second associating comprises accessing a consumer database comprising data regarding consumers.

11. A marketing method comprising the following steps:
identifying a plurality of business personnel associated with a product used by one or more business entity;
providing a first file responsive to the identifying, the first file comprising a plurality of business attitude segments of the business personnel regarding the product and personal data of the business personnel; and
providing a second file using the business attitude segments and the personal data of the first file, the second file associating a plurality of consumer attitude segments with the business attitude segments.

12. The method in accordance with claim 11 wherein the identifying comprises identifying using a marketing research entity.

13. The method in accordance with claim 11 wherein the providing the second file comprises communicating the first file to a consumer database entity and receiving the second file from the consumer database entity.

14. The method in accordance with claim 13 wherein the first file comprises personal data of the business personnel permitting the consumer database entity to associate the business attitude segments of the business personnel with the consumer attitude segments.

15. The method in accordance with claim 11 wherein the second file identifies one of the consumer attitude segments for an individual one of the business attitude segments.

16. The method in accordance with claim 11 wherein the second file identifies the one of the consumer attitude segments having the greatest concentration of the individual one of the business attitude segments associated therewith.

17. The method in accordance with claim 11 wherein the second file identifies an index identifying a plurality of consumer attitude segments for an individual one of the business attitude segments.

18. A business personnel marketing method comprising the following steps:
first identifying a plurality of business personnel associated with a product used by one or more business entity;
linking the business personnel to respective consumer identities; and
associating the business personnel with a plurality of consumer attitude segments after the linking.

19. The method in accordance with claim 18 further comprising communicating a message regarding the product after the second identifying.

20. The method in accordance with claim 18 further comprising: associating the business personnel with one of a plurality of business attitude segments regarding the product; and providing an index identifying a plurality of consumer attitude segments for an individual one of the business attitude segments.

21. The method in accordance with claim 18 wherein the linking comprises linking using personal data of the business personnel.
